(19) United States
(12) Patent Application Publication
(10) Pub. No.: US 2017/0285136 A1
(43) Pub. Date: Oct. 5, 2017

(54) RADAR SENSOR

(71) Applicant: Hella KGaA Hueck & Co., Lippstadt (DE)

(72) Inventor: Thomas Hesse, Paderborn (DE)

(21) Appl. No.: 15/508,141

(22) PCT Filed: Aug. 12, 2015
(86) PCT No.: PCT/EP2015/068544

§ 371 Date: Mar. 2, 2017

(30) Foreign Application Priority Data
Sep. 5, 2014 (DE) 102014112806.0

(51) Int. Cl. G01S 7/02; G01S 7/40

(52) U.S. Cl. CPC G01S 7/023; G01S 7/4021; G01S 7/4008; G01S 13/931

(57) ABSTRACT

A radar sensor for generating and transmitting a transmit signal in a frequency band. The radar sensor includes a control device with an oscillator. One input of the oscillator is connected to the control device via a converter. The oscillator can be activated using the control device for generating the signal and the signal generated using the oscillator can be picked up at an output of the oscillator. At least one transmit antenna is provided for sending the signal present at the output of the oscillator The transmit antenna is connected to the output of the oscillator with at least one receive channel for receiving a receive signal, for processing the receive signal and for forwarding the processed receive signal to the control device. The receive channel has at least one receiving antenna and one mixer for mixing the receive signal with the signal present at the output of the oscillator. The mixer is connected to the output of the oscillator. A controllable power switch is provided in the transmit branch to attenuate or interrupt the forwarding of the signal at the output of the oscillator to the transmit antenna. If forwarding to the transmit antenna is attenuated or interrupted, a triggering of the oscillator can be carried out for interference detection.

### CROSS REFERENCE

This application claims priority to PCT Patent Application No. PCT/EP2015/068544, filed 12 Aug. 2015, which itself claims priority to German Application No. 10 2014 112806.0, filed 5 Sep. 2014, the entirety of both of which are hereby incorporated by reference.

### FIELD OF THE INVENTION

This invention is a radar sensor (more specifically, a radar sensor for vehicles). The invention also includes a method for operating a radar sensor.

### BACKGROUND OF THE INVENTION

The use of radar sensors in vehicles in becoming more and more frequent. These types of radar sensors can be used in driver assistance systems to safely detect oncoming vehicles at long distance and to determine their position and speed with maximum accuracy. This can be used to trigger activation processes for driver assistance functions or warnings. These activation processes include adjusting the illumination range of the headlamps, and the illumination of the street in front of the vehicle itself, providing glare protection from oncoming traffic, activating a braking function, biasing safety devices in the event of an expected impact or adjusting the speed of the vehicle itself based on the driving behavior of vehicles ahead. In addition, radar sensors are used to monitor the area immediately around the vehicle.

Currently, when detecting objects, such radar sensors operate under the assumption that the corresponding radar sensor in the area to be monitored is the sole source of a corresponding radar signal. This is the only condition that can ensure fault-free detection of objects in accordance with the general principle behind radar, which states that the receive signals of a radar sensor essentially form a composite of the sensor's transmit signal components reflected by the objects to be detected and shifted in time and phase and, if applicable, frequency in relation to the transmit signal.

The increasing spread of the use of radar technology in the automotive sector increases the probability of the use of two autonomous, unsynchronized radar sensors in an area with a diameter smaller than the typical range of a radar sensor. This can occur in high-traffic scenarios within urban areas but also on highways. If two radar sensors are close to one another in the same small space, the signals of both radar sensors overlap, which can cause unwanted interference with the receive signals of both sensors. Evaluating these interference effects as an actual receive signal would yield false results with respect to the monitored area and objects.

In accordance with the state of the art, radar sensors are used with the ability to detect interference effects within the regular receive signals of a radar sensor.

In these radar sensors, the signal components of a “chirp” transmit signal are picked up by several receiving antennas for target detection. These components are guided to the sensor by reflections off objects to be detected in the sensor environment. If an external interference signal is present as a radar signal from another, more distant radar sensor, this can lead to overlap in the receive signals from both sensors in the vicinity of the radar sensor in question (also referred to as the ego radar sensor).

In the ego radar sensor, interference from the interference signal specifically occurs if the ego radar sensor and interfering sensor have a frequency separation with a value below the upper limit frequency of a band-pass filter in the ego radar sensor. In this case, the signal components of the interfering sensor are not suppressed by the band-pass filter of the ego radar sensor. Experience shows that disruptions caused by interference are very short-lived in most cases. Nevertheless, lengthier interference phases can occur. The effect from interference with the scanned receive signals, which serve as this basis for overall target detection, causes a significant increase in the signal energy. During brief interference phases, this acts on the receive signal, overlaying a pulse-like distortion caused by the interference over the sinusoidal, modulated receive signal. The sine wave is formed from reflections of the transmitted radar signal off real objects, while the pulse-like signal is generated as a parasitic signal upon brief interference of the ego sensor's signal together with the signal of the second radar sensor.

Current conventional strategies attempt to counteract this pulse-like interference with statistical methods in an effort to detect pulsed interference in the sinusoidal signal. This pulsed interference is corrected by replacing the distorted signal values with the signal values that are most likely to be accurate based on the amplitude values in the immediate vicinity of the distorted values. This attempts to the continue the undistorted curve of the receive signal over time into the distorted time domain.

However, using these strategies to detect and correct prolonged interference may be impossible or be possible only with a high risk of error.

This method is also very CPU-intensive. This is because amplitude statistics have to be generated and evaluated for all receive signals in order to detect this interference. This strains the computing capacity of the microprocessor, meaning that computing capacity is not available for other tasks.

The frequency with which calculations are conducted also contributes to high computing capacity requirements because the receive signals have to be analyzed in each cycle prior to actual signal processing. The computing time used for these tasks is deducted from the entire computing time of the microprocessor and also can no longer be used for signal processing even if no interference is present, which is most often the case.

### SUMMARY OF THE INVENTION

The purpose of the invention is to create a radar sensor and a method for operating a radar sensor that is superior to current state-of-the-art technology and, unlike these technologies, can detect and correct prolonged interference.

A sample embodiment of this invention is a radar sensor for generating and transmitting a transmit signal in a frequency band, with a control device and an oscillator, where one specific input of the oscillator is connected to the control device via a converter, the oscillator can be activated by the control device in order to generate the transmit signal and the transmit signal generated by the oscillator can be picked up at an output of the oscillator, with at least one transmit antenna for transmitting the signal present at the output of the oscillator, where the transmit antenna is connected to the output of the oscillator, with at least one receive channel for receiving a receive signal, processing the receive signal and forwarding the processed receive signal to the control device, where the receive channel features at least one receiving antenna and a mixer for mixing the receive signal with the signal present at the output of the oscillator, where the mixer is connected to the output of the oscillator, where a controllable power switch is provided in the transmit branch in order to attenuate or interrupt forwarding of the signal at the output of the oscillator to the transmit antenna, where the oscillator can be triggered for interference detection when forwarding to the transmit antenna has been attenuated or interrupted. Accordingly, interference can be tested in activated temporal phases and even detected if another radar sensor is in the vicinity and could interrupt the receive signal through interference.

This is why it is suitable to have the power switch situated between the oscillator and transmit antenna in the transmit branch. This still allows the output signal of the oscillator to be directed to the mixers, while the connection to the transmit antenna is attenuated or interrupted and no transmit signal is sent.

It is also advantageous if the power switch can be activated by a control unit in order to attenuate or interrupt the signal connection between the oscillator and transmit antenna. The enables control of the time or time phase for interference detection.

It is particularly advantageous if the power switch can be activated by the control unit in order to control attenuation or interruption. In such cases, the control devices can control the oscillator and power switch in order to detect interference and operate the radar sensor for object detection.

It is also advantageous if the control unit can be activated by the control devices via an interface. In such cases, the control unit can activate normal operation for object detection and interference detection to initiate corrective action when interference is detected.

It is also advantageous if triggering of the oscillator for interference detection includes generation of an internal signal to be forwarded to at least one mixer with a frequency variation. The frequency variation should be sufficient to locate the interrupting radar signal if it is available. Preferably, the scope of frequency variation is limited to the active operating range of the radar sensor.

It is particularly advantageous if the frequency variation includes a frequency sweep via an adjustable frequency width. Here, the frequency width is the active bandwidth of the radar sensor.

It is also particularly advantageous if the received receive signal can be mixed with the internal signal during the interference detection phase and this processes signal analyzed to detect interference. In this case, no transmit signal should be present. As such, each receivable signal (with the exception of parasitic effects) is a signal that is generated by an outside source. This allows signals to be detected that do not originate from the radar sensor (ego radar sensor).

It is also particularly advantageous if the receive signal can be purified when interference is detected. When interference is detected, actions are initiated to purify the receive signal with respect to the interference in order to extract the purest possible receive signal without interference.

The characteristics in Claim 10 fulfill the purpose of this invention with respect to the method.

One embodiment of the invention pertains to a method for operating a radar sensor, where the receive signal is monitored for the presence of any interference and, if interference is detected, the receive signal is purified, where the transmit signal is attenuated or interrupted, where, if the transmit signal is attenuated or interrupted, the oscillator is triggered for interference detection.

It is also advantageous if the triggering of the oscillator for interference detection includes the generation of an internal signal to be forwarded to at least one mixer with a frequency variation, where the received receive signal is mixed with the internal signal during the interference detection phase and this processed signal is analyzed to detect interference.

It is also particularly useful if the receive signal is purified when interference is detected.

In these registration documents, interference is used to refer both to unwanted effects on signal propagation and to the resulting noise during processing.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a schematic diagram of a radar sensor.

FIG. 2 is a diagram outlining the invention.

FIG. 3 is a diagram outlining the invention.

FIG. 4 is a diagram outlining the invention.

### DETAILED DESCRIPTION OF THE DRAWINGS

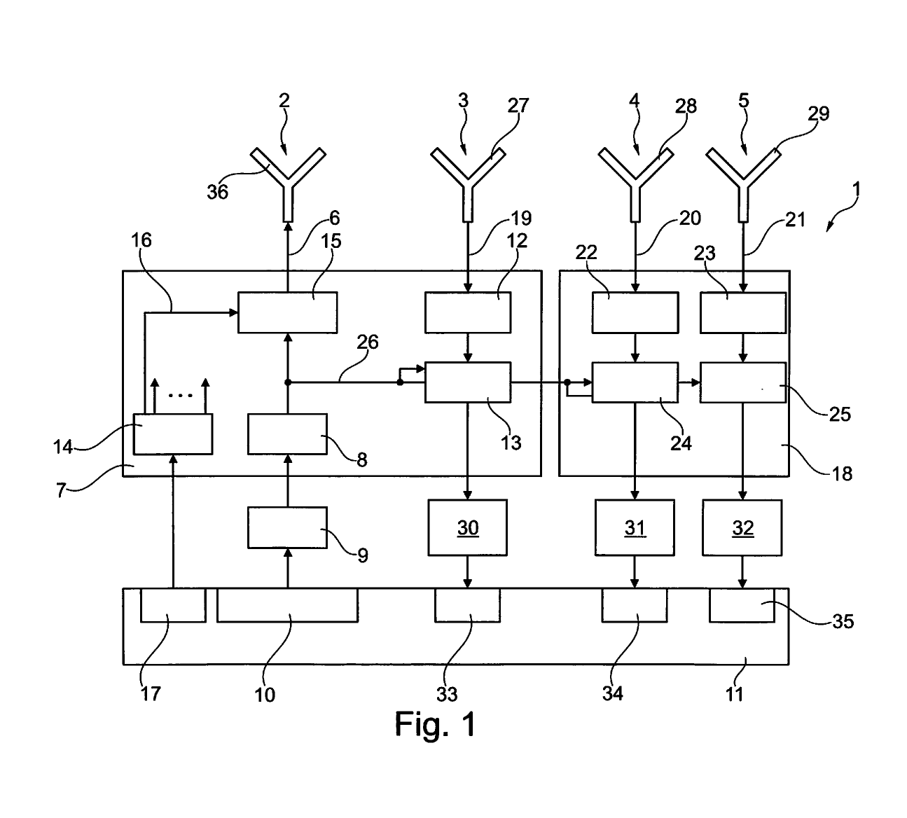

FIG. 1 includes a schematic diagram that illustrates the design of a radar sensor (1). The radar sensor (1) features a transmit branch (2) and three receive channels (3, 4, 5) The transmit branch (2) sends a transmit signal (6) and the receive channels (3, 4, 5) receive receive signals (19, 20, 21).

The transmit signal (6), or TX signal, particularly in the GHz range transmission frequency, such as around 24 GHz, is generated by activating a Monolithic Microwave Integrated Circuit or MMIC (7) and an integrated, voltage-controlled oscillator or VCO (8) using a digital-to-analog converter or DAC (9) in the transmit branch (2). The digital-to-analog converter (9) is activated using a digital signal process or DSP (11) in a digital-to-analog converter triggering process (10). The Monolithic Microwave Integrated Circuit 7 (MMIC) is a TX-RX-MMIC. On the receiver side, this circuit has an integrated amplifier (12), which is an LNA, and a mixer (13) for one or more receive channels (3). The transmit signal (6) is sent/emitted by the transmit antenna (36).

The MMIC (7) also features an integrated control unit (14), which can trigger a power switch (15) using a signal (16) in order to trigger the transmit signal (6). The control unit (14) can be triggered by an SPI interface (17) of the signal processor (11). Therefore, the control unit (14) can be programmed by the signal processor (11) via the SPI interface (17). The TX-RX-MMIC (7) integrates the transmit branch (2) and a receive branch (3). Optionally, more than just one receive branch can be integrated.

In addition, another MMIC (18) is provided as a so-called RX-MMIC in which two receive channels (4, 5) are integrated. This MMIC (18) integrates one amplifier (22, 23) (LNA or Low Noise Amplifier) and a corresponding mixer (24, 25) into each receive channel (4, 5).

Equivalent to the analog voltage curve created by the digital-to-analog converter (9), a signal settles in the GHz range, for example around 24 GHz, with a corresponding frequency sequence. This signal is the transmit signal (6) (TX signal) as well as the LO signal (26) of receive channels (3, 4, 5) guided to the mixers (13, 24, 25). Through this LO signal (26), the signals received (19, 20, 21) through the receiving antennas (27, 28, 29) are mixed into the base band. These signals are first amplified using amplifiers (12, 22, 23) (LNA). After mixing, the signals are filtered using the filters (30, 31, 32) and sampled using an analog-to-digital converter (33, 34, 35) (ADC) integrated into the digital signal processor (11) (DSP) and subsequent target detection through signal processing in the digital signal processor (11) (DSP).

The radar sensor (1) is controlled by a digital signal processor (DSP) (11). This control includes factors such as the transmit signal creation and the chronologically coupled sampling of receive signals (19 to 21) of the receiving antennas (27 to 29).

The new type of MMICs installed in these radar sensors (1) exhibit a high degree of integration. The receiver-side amplifiers (LNA) (12) and mixers (13) are integrated into the MMIC (7) as well as the control unit (14), which can be programmed via the SPI interface (17). This control unit can be used to configure a series of modules integrated into the TX-RX MMIC (7), such as the power switch (15). This provides the ability to attenuate the transmit signal (6) (TX signal) by at least 20 dB using a power switch (15) and thus de facto disable it. The special feature is that this attenuation is limited to the transmit signal (6) (TX signal). The MMIC's internal LO signal (26) for mixing the receive signals (19, 20, 21) is not attenuated, however, and thus is not affected by the attenuation.

This configuration is used to carry out detection of interference of signals from the present so-called ego radar sensor (1) with the signals of other, additional radar sensors.

When the transmit signal (6) is attenuated, i.e. de facto disabled, a regular sampling takes place of receive signals (19, 20, 21), their amplification through amplifiers (12, 22, 23) in the GHz transmission frequency range, for example at 24 GHz, the mixing using the mixers (13, 24, 25) into the base band using the existing LO signal (26), any band-pass filtering using band-pass filters (30, 31, 32) and sampling using analog-to-digital converters (33, 34, 35).

If there is no interference, the receive signals (19, 20, 21) at the input of receiving antennas (27, 28, 29) are also virtually zero and thus the same is true of the output signals at the amplifiers (12, 22, 23) and the signals at the outputs (13, 24, 25). The sampled signals should only potentially show effects from charge-switching processes of the band-pass filters (30, 31, 32); no other effects are to be expected. No parts of the signal are to be expected other than these very low-frequency signal curves.

However, if there is interference through an interference signal, for example with a constant frequency, a receive signal is generated at the input of ADC channels of the analog-to-digital converter (33, 34, 35) with sufficiently low frequency distance between oscillator 8 (VCO) and the interference source. This receive signal has significantly higher amplitude than in the case described earlier. This makes it possible to detect any interference.

Therefore, it is possible to distinguish one case from another using suitable digital signal processing. A certain significance is attained by the choice of frequency of the oscillator (VCO frequency) or the frequency curve of the oscillator (8), because only in the case of a small separation between the frequency of the oscillator and the (initially unknown and random) frequency of the source of interference are corresponding signal parts to be expected in the sampled signals.

Therefore, the frequency curve of the oscillator should, as far as possible, overlap the entire frequency range of the ego radar sensor (1) to be monitored and the frequency range can advantageously be selected such that, for a random frequency series of the source of interference, a time interval greater than the inverse of the sampling rate of the ego sensor exists at which the frequency separation of both sensors is sufficiently low for detection in the ego radar sensor (1).

The present inventive idea thus provides that the present introduced inventive method/inventive equipment, like the radar sensor, uses a VCO signal designed explicitly for the purpose of interference detection.

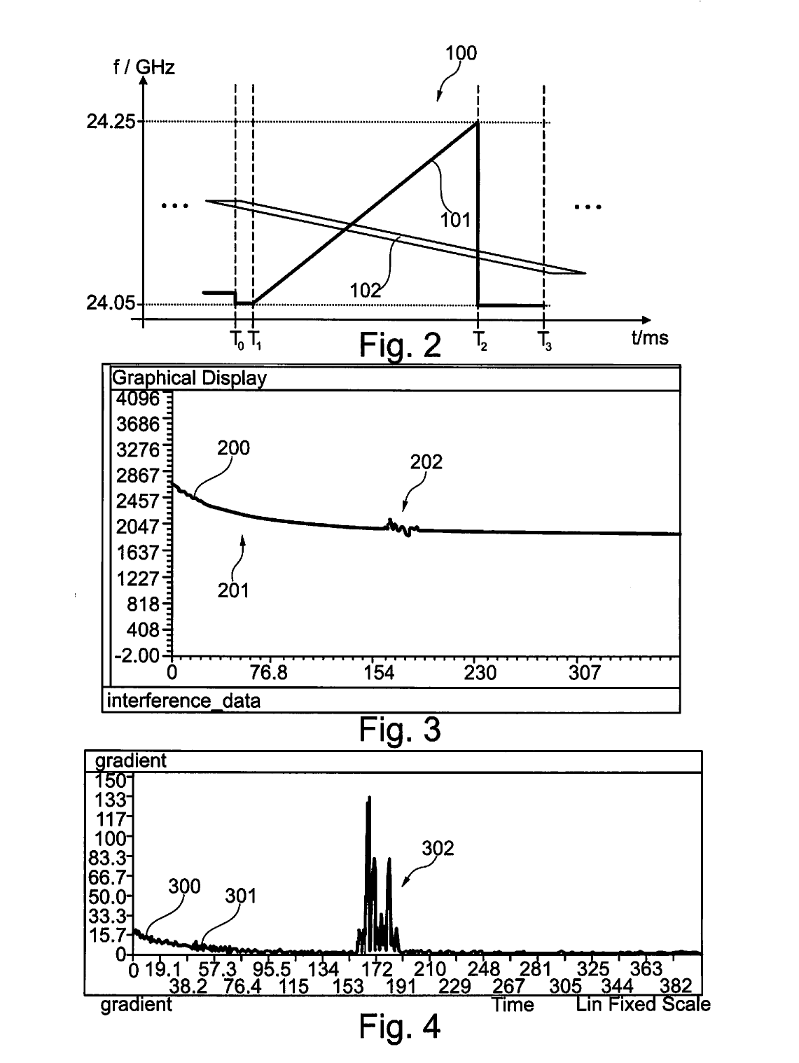

As part of the inventive idea, an LO signal search cycle is suggested for triggering of the radar sensor (1) (ego radar sensor) which is a linear frequency curve of the oscillator signal (VCO signal) or LO signal (26) over the entire frequency range to be monitored. This LO signal search cycle is shown in FIG. 2 as an example along with the corresponding configuration times.

FIG. 2 shows a diagram (100), in which the frequency in GHz is plotted as an example in the frequency range of about 24 GHz as a function of the time (t) in ms. This also shows an LO signal pass (101) between times T0 and T3 which begins at time T0 at 24.05 GHz, which in the 24 GHz range corresponds to the lower limit of the permitted frequency range, remains constant until time T1 and then increases in linear fashion from T1 to T2 to the value of 24.25 GHz, which in the 24 GHz range corresponds to the upper limit of the permitted frequency range before the value jumps back down to 24.05 GHz at T2 and remains constant at 24.05 GHz until T3. The LO signal (26) thus exhibits a sawtooth curve and the LO signal passes through the relevant frequency range from the lower limit frequency of the permitted frequency range to the upper limit frequency of the permitted frequency range. The frequency range covered by the LO signal search cycle thus extends advantageously over the entire permitted frequency band. No frequency band violation exists here because the VCO signal is not emitted via the transmit branch of the sensor, but instead exists only as a LO signal within the sensor or MMIC.

FIG. 2 also shows an interference signal (102), which drops from approx. 24.16 GHz to 24.1 GHz in the time window shown. The search cycle of the LO signal (101) crosses the interference signal (102) between T1 and T2 and both signals have approximately the same frequency at the point of intersection.

A special feature of the search cycle (101) is that it can be advantageous that its slope is steeper compared to an increase of a regular radar measurement cycle. The time duration T2-T1 for covering the permitted frequency band is at approximately 11 ms. The increase can also be in larger or smaller time domains, for example from 5 to 50 ms.

Taken together, both properties have the effect that for nearly any frequency curves of an interference signal within the examined frequency band, both frequencies (101, 102) are briefly approximated, making it possible to detect the interference signal on the receiver side. In particular, an interference signal (102), which represents a slow frequency sweep as shown in FIG. 2, can be detected reliably through the described LO signal search cycle (101).

In addition to the actual search cycle from T1 to T2, an advance phase and an after-run phase (T0 to T1 and T2 to T3) are provided, which are likewise shown in FIG. 2. If, at time T0, the transmit signal (6) is disabled and the start frequency of the search cycle is configured, an advance phase T1-T0 is advantageous before starting the search cycle as well as sampling the corresponding receive signals to minimize the effects of settling processes of the VCO frequency and of charge-switching processes of the receiver-side band-pass filters (30 to 32).

An after-run phase (T2 to T3) is likewise advantageous to minimize corresponding effects caused by switching the transmit signal (6) back on and by configuring the repetition frequency of the oscillator (VCO) at time T2. The time durations provided as advance time/after-run time are approximately 1 ms for the advance time T0 to T1 and approximately 3 ms for the after-run phase T2 to T3.

A typical receive signal (200), which was picked up during a LO signal search cycle, is shown in FIG. 3. In FIG. 3, a signal (200) can be identified in a diagram which, in addition to the low-frequency part of the signal (201), is equivalent to an exponential function and is invoked by charge-switching processes of the band-pass filter resulting from the switching operations at time T0, the pulsed part (202) of the interference signal can be identified. The presence of multiple interfering pulses can be explained in that, for test purposes, another, unsynchronized radar sensor was used as a source of interference, which transmits frequencies of a complex frequency scheme and, as result, multiple approximations in the frequency range within a narrow time interval result in accordance with FIG. 2.

Through a processing of the signal (200), in particular using digital signal processing means, the parts of the interference signal (202) and thus the existence of the interference signal can be detected. For example, in a first step, the first derivation of the signal (200) shown in FIG. 3 can be formed. The amount of the resulting signal from the derivation of signal (200) of FIG. 3 is illustrated in FIG. 4.

FIG. 4 shows a diagram that illustrates the chronological derivation (300) of the signal (200) of FIG. 3. The attenuation of the low-frequency part of the signal (301) is readily visible, which decreases slightly for short times compared to the interference parts (302).

Starting from the processed signal (300), in a following step, the detection of the signal peaks (302) caused by interference can be carried out, for example using a classic peak detection algorithm.

For example, an OS-CFAR (Ordered Statistics Constant False Alarm Rate) algorithm can be used as a peak detection method. This method enables robust detection of an interference signal, for example.

After successful detection of a source of interference in the ego radar sensor (1), methods to repair signals with interference can be run efficiently. If, however, no interference is present (which is true in most cases) and this lack of interference is likewise detected by the presented method, the methods to repair signals with interference do not have to be carried out and the CPU time thus saved can be used for improved signal processing for radar target detection.

### LIST OF REFERENCE SYMBOLS

1 Radar sensor
2 Transmit branch
3 Receive branch
4 Receive branch
5 Receive branch
6 Transmit signal
7 MMIC, monolithic microwave-integrated circuit
8 Oscillator
9 Digital-to-analog converter
10 Digital-to-analog converter triggering
11 Digital signal processor
12 Amplifier (LNA)
13 Mixer
14 Control unit
15 Power switch
16 Signal
17 SPI interface
18 MMIC, monolithic microwave-integrated circuit
19 Receive signal
20 Receive signal
21 Receive signal
22 Amplifier (LNA)
23 Amplifier (LNA)
24 Mixer
25 Mixer
26 LO signal
27 Receive antenna
28 Receive antenna
29 Receive antenna
30 Filter
31 Filter
32 Filter
33 Analog-to-digital converter
34 Analog-to-digital converter
35 Analog-to-digital converter
36 Transmit antenna
100 Diagram
101 LO signal
102 Interference signal
200 Receive signal
201 Part of the signal
202 Pulsed part
300 Timing derivation
301 Timing derivation of the low-frequency part of the signal
302 Timing derivation of the interference part

1. A radar sensor for generating and transmitting a transmit signal in a frequency band, said radar sensor comprising:
a control device,
an oscillator including an input, where the input of the oscillator is connected to the control device via a converter to activate the oscillator to generate the transmit signal wherein the transmit signal generated by the oscillator can be picked up at an output of the oscillator,
at least one transmit antenna connected to the output of the oscillator for transmitting the transmit signal present at the output of the oscillator,
at least one receive channel for receiving a receive signal, processing the receive signal and forwarding the processed receive signal to the control device,
wherein the receive channel features at least one receiving antenna and one mixer for mixing the receive signal with the transmit signal present at the output of the oscillator, where the mixer is connected to the output of the oscillator,
wherein a controllable power switch is included in the transmit branch to attenuate or interrupt forwarding of the signal at the output of the oscillator to the transmit antenna,
wherein the oscillator can be triggered for interference detection when forwarding to the transmit antenna is attenuated or interrupted.

2. The radar sensor in accordance with claim 1, wherein the power switch is situated in the transmit branch between the oscillator and transmit antenna.

3. The radar sensor in accordance with claim 1, wherein the power switch can be activated by a control unit in order to attenuate or interrupt the signal connection between the oscillator and transmit antenna.

4. The radar sensor in accordance with claim 3, wherein the power switch can be activated by the control unit in order to control the attenuation or interruption process.

5. The radar sensor in accordance with claim 3, wherein the control device can be activated by the control devices via an interface.

6. The radar sensor in accordance with claim 1, wherein triggering of the oscillator for interference detection includes generation of an internal signal to be forwarded to at least one mixer with a frequency variation.

7. The radar sensor in accordance with claim 6, wherein frequency variation includes a frequency sweep via an adjustable frequency width.

8. The radar sensor in accordance with claim 1, wherein the received receive signal can be mixed with the internal signal during the interference detection phase and this process signal can be analyzed to detect interference.

9. The radar sensor in accordance with claim 1, wherein the receive signal can be purified when interference is detected.

10. A method for operating the radar sensor of claim 1, comprising the steps of:
monitoring wherein the receive signal is monitored for interference;
purifying the receive signal is purified when interference is detected,
attenuating or interrupting the transmit signal to detect interference,
triggering the oscillator when the transmit signal is attenuated or interrupted in order to detect interference.

11. The method in accordance with claim 10, wherein the oscillator triggering to detect interference generates an internal signal that is forwarded to at least one mixer with a frequency variation, where the received receive signal is mixed with the internal signal during the interference detection phase and this processed signal is analyzed to detect interference.

12. The method in accordance with claim 11, wherein the receive signal is purified when interference is detected.
